(19) United States
(12) Patent Application Publication
(10) Pub. No.: US 2017/0351394 A1
(43) Pub. Date: Dec. 7, 2017

(54) INFORMATION PROCESSING APPARATUS AND METHOD OF CONTROLLING SAME

(71) Applicant: Sharp Kabushiki Kaisha, Sakai City, Osaka (JP)

(72) Inventors: Kazuhito SUMIDA, Sakai City (JP); Kiyoyuki MIYAZAWA, Sakai City (JP); Yuhsuke HIRANO, Sakai City (JP)

(21) Appl. No.: 15/535,418

(22) PCT Filed: Jan. 12, 2016
(86) PCT No.: PCT/JP2016/050734

§ 371 Date: Jun. 13, 2017

(30) Foreign Application Priority Data
Jan. 15, 2015 (JP) 2015-006037

(51) Int. Cl. G06F 3/0485; G06F 3/0488; G06F 3/0354

(52) U.S. Cl. CPC G06F 3/0485; G06F 3/03547; G06F 3/0488

(57) ABSTRACT

An object of the present invention is to realize a simpler operation in an information processing apparatus including a display section and an object detecting section. A mobile phone (10) including a display section (14) and a touch pad (16) undergoes a transition from a pointer mode to a scroll mode in a case where a touch duration time passed beyond a threshold time (T1), and performs an action corresponding to a position of a pointer in a case where the touch duration time passed beyond a threshold time (T2).

### TECHNICAL FIELD

The present invention relates to an information processing apparatus and a method of controlling the information processing apparatus. To be more specific, the present invention relates to an information processing apparatus including a display section and an object detecting section, and a method of controlling the information processing apparatus.

### BACKGROUND ART

Patent Literature 1 discloses a pointer display device having: a scroll mode in which a displayed content can be scrolled with use of a touch panel on a display screen; and a pointer mode in which a selection target displayed on the display screen can be selected with use of the touch panel, wherein long pressing on a touch panel allows a transition between the modes.

### CITATION LIST

### Patent Literature

[Patent Literature 1]

Japanese Patent Application Publication, Tokukai, No. 2011-170901 (Sep. 1, 2011)

### SUMMARY OF INVENTION

### Technical Problem

However, in the technique disclosed in Patent Literature 1, in a case where a user performs (i) a transition between the modes and (ii) an action other than the transition, the user is required to temporarily detach the user's finger from the touch panel after performing one of the (i) and (ii) and before performing the other of the (i) and (ii). This enforces the user to make complicated operations.

Here, the inventors of the present invention have developed, based on an original idea, an information processing apparatus including a display section and an object detecting section having a planar detection region where an object which comes close to or in contact with the detection region is detected, the detection region being located differently from a display region of the display section. The inventors of the present invention have been diligently studied realizing a simpler operation in such an information processing apparatus.

The present invention was made in view of the foregoing problem. A main object of the present invention is to provide a technique for realizing a simpler operation for an image processing apparatus including a display section and an object detecting section.

### Solution to Problem

In order to solve the foregoing problem, an information processing apparatus in accordance with an aspect of the present invention includes: a display section; an object detecting section having a planar detection region where an object which comes close to or is in touch with the detection region is detected, the detection region being located differently from a display region of the display section; a positional information obtaining section configured to obtain positional information indicative of a location where the object detecting section detected the object; a display control section configured to, (i) in a first mode, determine a location of a pointer on the display region in accordance with the positional information and (ii) in a second mode, control at least a part of the display region to scroll in accordance with a change in the positional information; and an operation control section configured to (i) control the display control section to undergo a transition from the first mode to the second mode, in a case where a duration time, during which the positional information continues to indicate a same location passed beyond a first threshold time, and (ii) initiate an action corresponding to the location of the pointer, in a case where the duration time passed beyond a second threshold time.

Furthermore, a method in accordance with an aspect of the present invention for controlling an information processing apparatus is a method of controlling an information processing apparatus, said apparatus comprising: a display section; an object detecting section, having a planar detection region where an object which comes close to or is in touch with the detection region is detected, the detection region being located differently from a display region of the display section; and a positional information obtaining section configured to obtain positional information indicative of a location where the object detecting section detected the object, said method comprising the steps of: (a) in a first mode, determining a location of a pointer on the display region in accordance with the positional information, and in a second mode, controlling at least a part of the display region to scroll in accordance with a change in the positional information; and (b) undergoing, in the step (a), a transition from the first mode to the second mode, in a case where a duration time, during which the positional information continues to indicate a same location, passed beyond a first threshold time, and initiating an action corresponding to the location of the pointer, in a case where the duration time passed beyond a second threshold time.

### Advantageous Effects of Invention

According to the aspect of the present invention, a user can successively undergo (i) a transition from the first mode to the second mode and (ii) other action, without temporarily detaching an object for operation (e.g. finger) from the object detecting section. This allows realizing a simpler operation in an information processing apparatus including a display section and an object detecting section.

### BRIEF DESCRIPTION OF DRAWINGS

FIG. 1 is a block diagram illustrating a configuration of a main part of a mobile phone in accordance with one embodiment of the present invention.

FIG. 2 is a drawing illustrating an outer appearance of a mobile phone in accordance with one embodiment of the present invention.

FIG. 3 is a flowchart illustrating an example process which is carried out when a user long presses on a touch pad in one embodiment of the present invention.

FIG. 4 is a drawing illustrating the example process which is carried out when a user long presses on a touch pad in one embodiment of the present invention.

FIG. 5 is a flowchart illustrating an example process which is carried out when a user long presses on a touch pad in one embodiment of the present invention.

FIG. 6 is a drawing illustrating the example process which is carried out when a user long presses on a touch pad in one embodiment of the present invention.

FIG. 7 is a block diagram illustrating a configuration of a main part of a mobile phone in accordance with one embodiment of the present invention.

FIG. 8 is a flowchart illustrating an example process which is carried out when a user long presses on a touch pad in one embodiment of the present invention.

FIG. 9 is a drawing illustrating the example process which is carried out when a user long presses on a touch pad in one embodiment of the present invention.

### DESCRIPTION OF EMBODIMENTS

### Embodiment 1

The following description will discuss Embodiment 1 of the present invention in details.

(Schematic Configuration of Mobile Phone)

The following description will discuss, with reference to FIG. 2, a mobile phone (information processing apparatus) in accordance with Embodiment 1. FIG. 2 is a drawing illustrating an outer appearance of a mobile phone 10 in accordance with Embodiment 1.

The mobile phone 10 is a so-called foldable mobile phone (see FIG. 2). A first housing 1 and a second housing 2 are connected with each other via a hinge 3, and are rotatably provided around an axis of the hinge 3. The first housing 1 and the second housing 2 each have, for example, substantially a flat plate shape. The first housing 1 has a display section 14 on a surface of the first housing 1. The second housing 2 has a hard key 15 on a surface of the second housing 2. Below the hard key 15 (inside the second housing 2), a sensor for a touch pad (object detecting section) 16 is provided so as to overlap with the hard key 15.

The mobile phone 10 is transformably provided between (i) an open state (a state illustrated in FIG. 2) in which the first housing 1 and the second housing 2 are opened and (ii) a closed state (not illustrated) in which a surface (display surface) of the first housing 1, on which surface the display section 14 is provided, faces a surface (operation surface) of the second housing 2 on which surface the hard key 15 is provided.

The display section 14 displays an image. For example, an LCD (liquid crystal display) or an organic EL display can be employed as the display section 14.

The hard key 15 is provided for a user to operate the mobile phone 10. The hard key 15 is a physical key which outputs a corresponding signal in response to the user having pressed the hard key 15. The hard key 15 is composed of, for example, a menu key, a numeric key, a cross key, a center key, an on-hook key, and an off-hook key etc.

The touch pad 16 is provided so that the user operates the mobile phone 10. The touch pad 16 includes the sensor, and detects, at regular intervals, an object (user's finger, stylus etc.) which comes close or is in touch with the touch pad 16, and outputs positional information indicative of a detected location (e.g. two-dimensional coordinates on the touch pad 16). A detection region, detected by the touch pad 16 on which region the object is detected, is a whole surface (operation surface) of the second housing 2 on which surface the hard key 15 is provided. That is, the operation surface of the second housing 2 serves as a surface at which the touch pad 16 detects. Accordingly, a key top surface of the hard key 15 is a part of the surface at which the touch pad 16 detects, and is located within the detection region. Examples of the sensor included in the touch pad 16 encompass an electrostatic capacitive sensor etc.

According to Embodiment 1, the touch pad 16 detects whether the user's finger touches the operation surface of the second housing 2. As illustrated in FIG. 2, the operation surface of the second housing 2 (the detection region of the touch pad 16) is located differently from the display surface (display region) of the display section 14.

The mobile phone 10 illustrated in FIG. 2 is of a foldable type. The present invention is, however, not limited as such, and can be a mobile phone of a straight type, a slide type, a biaxial hinge type or the like. Embodiment 1 exemplifies the mobile phone. The present invention is, however, not limited as such. The present invention is applicable to any information processing apparatus including (i) a display section and (ii) an object detecting section having a planar detection region where an object, which comes close or is in touch with a region, is to be detected, the region being located differently from a display region of the display section. The present invention is applicable to, for example, laptop computers, portable game machines, digital cameras, digital video cameras, portable music players etc.

(Operation System of Mobile Phone)

As has been described, the mobile phone 10 includes two operation sections (input sections), i.e. the hard key 15 and the touch pad 16. In order to facilitate an operation which the user conducts via the touch pad 16 (in order to prevent operation mistake), the mobile phone 10 has three modes: “key operation mode,” “pointer mode” (first mode), and “scroll mode” (second mode).

The key operation mode is a mode in which a user can operate the mobile phone 10 only via the hard key 15. That is, in the key operation mode, an operation conducted by the user via the touch pad 16 is disabled. In the key operation mode, the user can, for example, (i) move a focus (select an item in a list) by operating the cross key, (ii) make a determination by pressing the center key, (iii) input a numeral or a character by operating the numeric key, (iv) start a phone call by pressing the off-hook key, and (v) end the phone call or application by pressing the on-hook key.

The mobile phone 10 undergoes a transition to the pointer mode, by long pressing on the off-hook key in the key operation mode. The mobile phone 10 undergoes a transition to the pointer mode, by starting a particular application in the key operation mode. At start-up of the mobile phone 10, the mobile phone 10 is in the key operation mode.

The pointer mode is a mode in which a cursor having an arrow shape is displayed on a screen so that a cursor moving operation and a determination operation via the touch pad 16 are enabled. The pointer mode has a cursor non-display state and a cursor display state. In the cursor non-display state, the cursor is displayed in response to the user (i) touching the touch pad 16 (operation surface of the second housing 2) and then (ii) swiping a little. That is, the mobile phone 10 undergoes the transition to the cursor display state. The user can conduct, in the pointer mode, an operation via the hard key 15 similarly with the key operation mode. The user can move, in the cursor display state, the cursor by swiping or flicking the touch pad 16. The user can also input, in the cursor display state, a determination at a location where the cursor is present, by single-tapping the touch pad 16 within a predetermined time (e.g. 1.5 sec.) after the cursor was moved. Furthermore, by double-tapping the touch pad 16, the user can input a determination at a location where the cursor is present. Pressing the hard key 15 in the cursor display state causes the cursor to be not displayed. That is, the mobile phone 10 undergoes a transition to the cursor non-display state. The mobile phone 10 also undergoes a transition to the cursor non-display state, in a case where a predetermined period of time has elapsed without conducting, in the cursor display state, an operation with respect to the touch pad 16.

The mobile phone 10 undergoes a transition to the key operation mode, by long pressing on the off-hook key in the pointer mode. The mobile phone 10 undergoes a transition to the key operation mode, by ending the particular application in the pointer mode. The mobile phone 10 undergoes a transition to the scroll mode, by long tapping on the touch pad 16 in the pointer mode. Note that in a case where the mobile phone 10 has undergone a transition to the pointer mode, the mobile phone 10 undergoes a transition to the cursor display state.

The user can scroll, in the scroll mode, a screen via the touch pad 16. In the scroll mode, by swiping or flicking the touch pad 16, the user can scroll the screen. Making long tap on the touch pad 16 allows the mobile phone 10 to perform a predetermined process corresponding to a running application. The mobile phone 10 undergoes a transition to the pointer mode, by single-tapping the touch pad 16 in the scroll mode. The mobile phone 10 undergoes a transition to the pointer mode, by making no operation on the touch pad 16 for a predetermined time in the scroll mode. Furthermore, the mobile phone 10 undergoes a transition to the key operation mode, by ending the particular application in the scroll mode.

(Configuration of Mobile Phone)

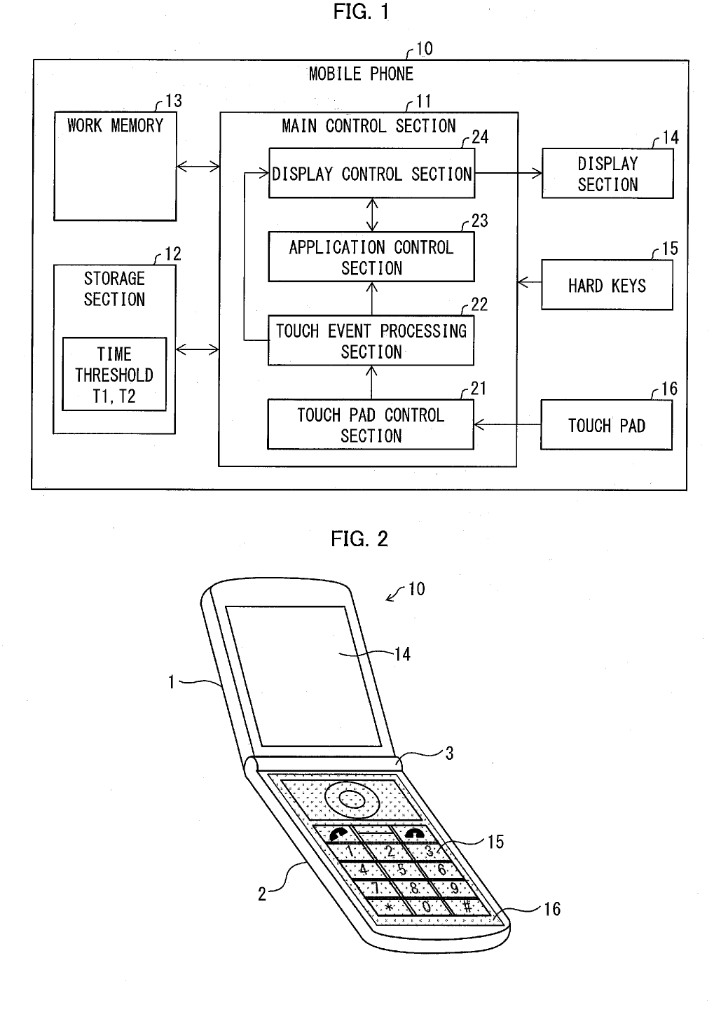

The following description will discuss, with reference to FIG. 1, a configuration and functions of the mobile phone 10. FIG. 1 is a block diagram illustrating a configuration of a main part of the mobile phone 10 in accordance with Embodiment 1.

As illustrated in FIG. 1, the mobile phone 10 includes a main control section 11, a storage section 12, a work memory 13, the display section 14, the hard key 15, and the touch pad 16. Note that the mobile phone 10 can further include members such as a communication section, an audio input section, and an audio output section, which are not illustrated because they are not related to a feature of the present invention.

The main control section 11 is realized, for example, by a CPU (Central Processing Unit). The storage section 12 is realized, for example, by a ROM (Read Only Memory). The work memory 13 is realized, for example, by a RAM (Random Access Memory). The main control section 11 executes a program which is read out from the storage section 12 to the work memory 13 so as to make various calculations and totally control sections included in the mobile phone 10. The storage section 12 stores therein a threshold time (first threshold time) T1 and a threshold time (second threshold time) T2.

According to Embodiment 1, the main control section 11 includes, as functional blocks, a touch pad control section (positional information obtaining section) 21, a touch event processing section (operation control section) 22, an application control section (operation control section) 23, and a display control section 24.

The touch pad control section 21 obtains positional information via the touch pad 16, and identifies a touch event based on the obtained positional information. The touch pad control section 21 creates event information indicative of the identified touch event, and notifies the touch event processing section 22 of the created event information.

Specifically, the touch pad control section 21 determines the classification of a touch event each time the touch pad 16 detects, and identifies a touch event. In a case where the touch pad control section 21 obtains positional information from the touch pad 16 in a state where the touch pad control section 21 did not obtain, on the last occasion, positional information from the touch pad 16, the touch pad control section 21 determines that a touchdown has occurred in a location indicated by the positional information thus obtained. In a case where the touch pad control section 21 does not obtain positional information from the touch pad 16 in a state where the touch pad control section 21 obtained, on the last occasion, positional information from the touch pad 16, the touch pad control section 21 determines that a touch-up has occurred at a location indicated by the positional information obtained on the last occasion. In a case where (i) the touch pad control section 21 obtains first positional information from the touch pad 16 in a state where the touch pad control section 21 obtained, on the last occasion, second positional information from the touch pad 16 and (ii) a location indicated by the first positional information is different from a location indicated by the second positional information, the touch pad control section 21 determines that a move has been made to the location indicated by the first positional information. The touch pad control section 21 thus identifies, as a touch event, a touch-up, a touchdown, or a move.

In a case where the touch pad control section 21 identifies the touch event, the touch pad control section 21 creates (i) event information including classification information indicative of the classification of the touch event (touchdown, touch-up, or move) and (ii) positional information. Specifically, in a case where the touch event is a touchdown, the event information includes positional information indicative of a location of the touchdown. In a case where the touch event is a touch-up, the event information includes positional information indicative of a location of the touch-up (location of the touchdown or move at the last occasion). In a case where the touch event is a move, the event information includes positional information indicative of a location of the move.

The touch event processing section 22 obtains the event information from the touch pad control section 21, processes the event information, and notifies the application control section 23 or the display control section 24 of a result of processing.

The following description will discuss how the touch event processing section 22 determines a user's operation conducted with respect to the touch pad 16. Examples of the user's operation include a touch operation, single tap, double tap, long tap, swipe, flick, and the like. The swipe and the flick are not distinguished, in Embodiment 1, from each other and are therefore collectively referred to as a scrolling operation. The touch event processing section 22 determines the classification of the user's operation based on one or a plurality of touch events identified by the touch pad control section 21.

The touch operation refers to a user's operation of bringing an object into contact with the touch pad 16. In a case where the touch event processing section 22 detects a touchdown, the touch event processing section 22 determines that a user conducted a touch operation. Single tap refers to a user's operation of bringing an object into contact with the touch pad 16 and shortly thereafter keeping the object away from the touch pad 16. The touch event processing section 22 determines that the user has carried out a single tap, in a case where the touch event processing section 22 detects a touchdown and then detects a touch-up next time or within a predetermined period of time. Double tap refers to a user's operation of performing twice in succession an operation of bringing an object into contact with the touch pad 16 and shortly thereafter keeping the object away from the touch pad 16. In a case where the touch event processing section 22 determines that a single tap has been made twice in succession within a predetermined period of time, the touch event processing section 22 determines that the user has carried out a double tap. Long tap refers to a user's operation of bringing an object into contact with the touch pad 16 and, after a predetermined period of time, keeping the object away from the touch pad 16. How the touch event processing section 22 determines a long tap will be described later. The scrolling operation refers to a user's operation of bringing an object into contact with the touch pad 16 and moving the object on the touch pad 16 while keeping the object in contact with the touch pad 16. In a case where the touch event processing section 22 detects a touchdown (or move) and then detects a move in which an object moves by a predetermined length or more, the touch event processing section 22 determines that the user has made the scrolling operation.

The touch event processing section 22 notifies the application control section 23 of a detected single tap, a detected double tap, and a detected long tap. Furthermore, the touch event processing section 22 notifies the display control section 24 of the positional information and the detected scrolling operation. The touch event processing section 22 can further notify the application control section 23 of a touch event itself, a scrolling operation etc.

The application control section 23 controls an application executable on the mobile phone 10. Specifically, the application control section 23 obtains a user's operation from the touch event processing section 22. In accordance with the obtained user's operation, the application control section 23 carries out a process predetermined in a running application. The application control section 23 can control any application, executable on the mobile phone 10, such as phone call, mail, image display, reproduction of a moving image, and document preparation.

The display control section 24 controls a content displayed by the display section 14, in accordance with an output from the application control section 23.

Furthermore, the display control section 24 controls (i) cursors displayed by the display section 14 and (ii) scrolling on a display region of the display section 14.

In the pointer mode, the display control section 24 determines a location of a pointer on the display region based on the positional information obtained from the touch event processing section 22, and controls the display section 14 to display a cursor 6 indicative of the pointer.

The display control section 24 causes, in the scroll mode, at least a part of the display region to scroll (to be slide-displayed) in accordance with the scrolling operation obtained from the touch event processing section 22. As described above, the scrolling operation is detected based on a change in positional information. The display control section 24 controls, in the scroll mode, the display section 14 to display a cursor 7 indicative of the scroll mode. In an embodiment, the display control section 24 can be configured to (i) cause at least a part of the display region to be moved and (ii) obtain, from the application control section 23, a content to be displayed on a region to which the at least a part has been moved.

Whether the display control section 24 operates in the pointer mode or in the scroll mode is controlled by the touch event processing section 22.

(Process Carried Out when User Long Presses on Touch Pad)

Subsequently, the following description will discuss a process carried out when a user long presses on the touch pad 16 (process corresponding to long press).

According to Embodiment 1, in a case where a user is long pressing on the touch pad 16, the touch event processing section 22 determines whether a touch duration time (duration time), during which positional information continues to indicate the same location, passed beyond each of the threshold times T1 and T2. In an embodiment, the touch event processing section 22 can determine that a touch duration time passed beyond the threshold times T1 and T2, in a case where the touch pad control section 21 did not detect a touch-up or a move for a period of time from a time at which the touch pad control section 21 detected a touchdown until the threshold times T1 and T2 elapsed. In another embodiment, the touch event processing section 22 can alternatively measure a touch duration time, during which the touch pad control section 21 has not detected a touch-up or a move since the touch pad control section 21 detected a touchdown, and can then compare the touch duration time with each of threshold times.

In a case where the touch duration time passed beyond the threshold time T1, the touch event processing section 22 controls the display control section 24 to undergo a transition from the pointer mode to the scroll mode. In a case where the touch duration time passed beyond the threshold time T2, the touch event processing section 22 notifies the application control section 23 of the long touch. The application control section 23 having obtained the long touch acts in accordance with a location of the pointer (e.g. display a list image 8).

Note that the application control section 23 can alternatively be configured to instruct the display control section 24 to control the display section 14 to display a display content including one or more alternatives 5, and then determine how to act in accordance with (i) whether a pointer matches an alternative and (ii) which alternative 5 the pointer matches.

Only by thus adjusting a period of time for long press, a user can (i) successively undergo a transition from a pointer mode to a scroll mode and (ii) can initiate another action, without temporarily detaching the finger 4 etc. from the touch pad 16.

Embodiment 1 is configured so that (i) the threshold time T1 is set to be shorter than the threshold time T2, (ii) in a case where the touch duration time passed beyond the threshold time T1, the display control section 24 is controlled to undergo a transition from the pointer mode to the scroll mode, (iii) in a case where the touch duration time passed beyond the threshold time T2, (a) the touch event processing section 22 and the application control section 23 control the display section 14 to display the list image 8 so that the list image 8 is overlaid on the display region of the display section 14 and (b) the display control section 24 controls the list image 8 to scroll in accordance with the scrolling operation which is detected in accordance with a change in positional information. With the configuration, it is possible that a user successively realizes (i) displaying of the list image 8 and (ii) scrolling of the list image 8, without detaching his/her finger 4 from the touch pad 16.

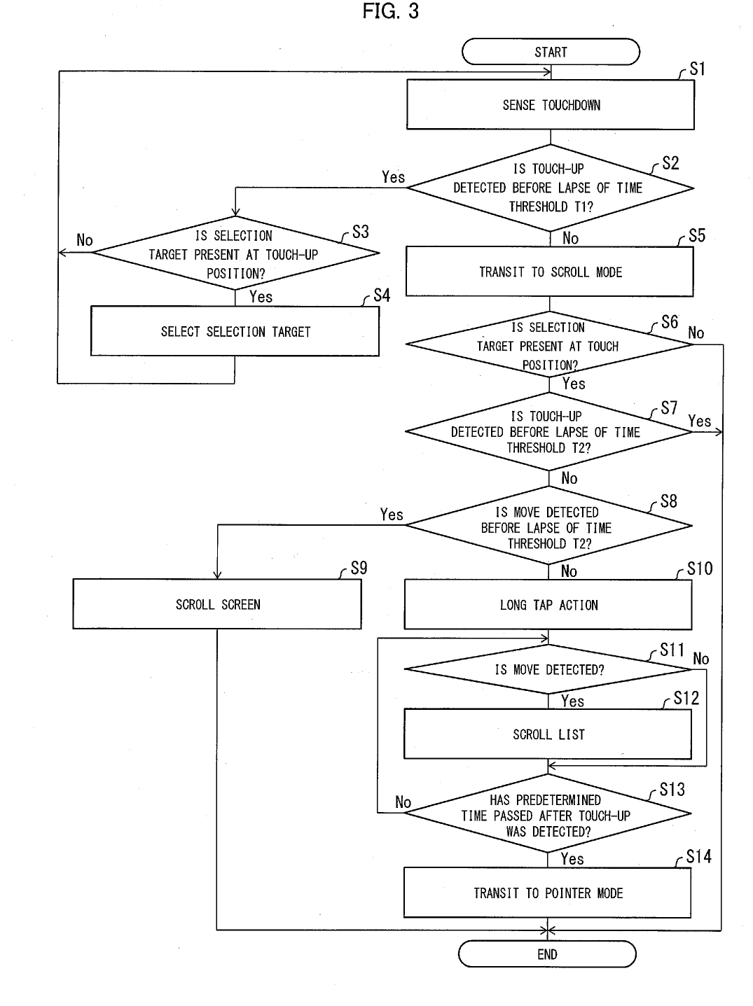

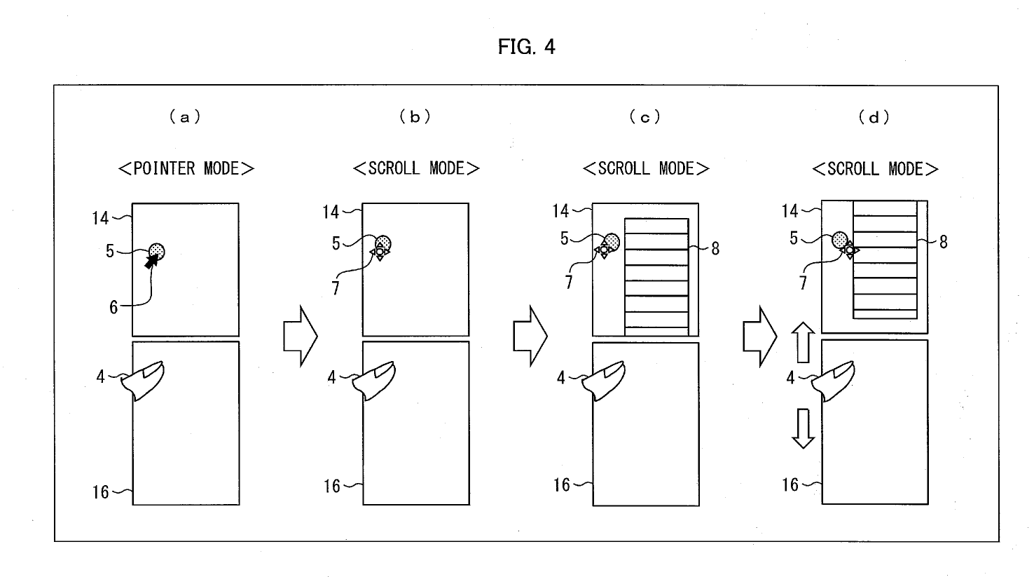

The following description will discuss in detail, with reference to FIGS. 3 and 4, a process which is carried out when a user long presses on the touch pad in Embodiment 1. FIG. 3 is a flowchart illustrating an example process which is carried out when a user long presses on a touch pad in Embodiment 1. FIG. 4 is a drawing illustrating the example process.

Assume a case where a user starts to long press with his/her finger 4 in a state where (i) the display control section 24 is operating in the pointer mode and (ii) a cursor 6 indicative of a pointer matches an alternative 5 (see (a) of FIG. 4). In such a case, the touch pad control section 21 detects a touchdown (step S1).

In a case where the touch event processing section obtains the touchdown from the touch pad control section 21, the touch event processing section 22 starts to determine whether a touch-up is detected before the touch duration time passes beyond the threshold time T1 (step S2). In a case where the touch event processing section 22 detected the touch-up before the touch duration time passes beyond the threshold time T1, the touch event processing section 22 detects a single tap as a user's operation, and then notifies the application control section 23 of such a single tap. The application control section 23 in turn determines whether the pointer matches the alternative 5, based on positional information obtained at a time of the touch-up (step S3). In a case where the pointer matches the alternative 5, the application control section initiates an action corresponding to the selected alternative 5 (step S4). Then, the process returns to the step S1.

In a case where the touch event processing section 22 did not detect, in the step S2, any touch-up before the touch duration time passes beyond the threshold time T1, the touch event processing section 22 controls the display control section 24 to undergo a transition from the pointer mode to the scroll mode (step S5). Consequently, as illustrated in (b) of FIG. 4, the display control section 24 controls the display section 14 to display the cursor 7 indicative of the scroll mode.

Then, the touch event processing section 22 obtains, from the application control section 23, information as to whether the alternative 5 is present at a touched location indicated by the positional information (step S6). In a case where the alternative 5 is not present, the touch event processing section 22 ends the process corresponding to the long pressing. On the other hand, in a case where the alternative 5 is present in a touched location, the touch event processing section 22 starts to determine (i) whether a touch-up is detected before the touch duration time passes beyond the threshold time T2 (step S7) and (ii) whether a move is detected before the touch duration time passes beyond the threshold time T2 (step S8).

In a case where a touch-up was detected before the touch duration time passes beyond the threshold time T2, the touch event processing section 22 ends the process corresponding to the long pressing. In a case where a move was detected before the touch duration time passes beyond the threshold time T2, the touch event processing section 22 notifies the display control section 24 of a scrolling operation. The display control section 24 in turn scrolls the display region in accordance with the scrolling operation (step S9).

On the other hand, in a case where neither a touch-up nor a move was detected before the touch duration time passes beyond the threshold time T2, the touch event processing section 22 detects a long touch, and then notifies the application control section 23 of the long touch. The application control section 23 in turn initiates an action corresponding to the alternative 5 which is located in the touch location (step S10). For example, as illustrated in (c) of FIG. 4, the application control section 23 can control the display section 14 to overlay, on its display region, the list image (overlaid display image) 8 including a list of subsequent actions related to the alternative 5, so that a user can select one of the subsequent actions in the list.

In the step S10, the action to be initiated is not limited to displaying of the list image. Alternatively, the application control section 23 can control the display section 14 to overlay, on its display region, any kind of image (overlaid display image) related to the alternative 5. The action to be initiated can alternatively be another kind of action such as initiation of a drag operation of the alternative 5.

As illustrated in (c) of FIG. 4, even in a case where (i) the size of the list image 8 is larger than the size of the display region (screen size) of the display section 14 and (ii) it is necessary to scroll the list image 8, the user can initiate scrolling of the list image 8 without conducting any other operation. This is because the mode has already undergone a transition to the scroll mode in the step S5.

That is, the touch event processing section 22 determines whether the touch pad control section 21 detects a move (step S11). In a case where the touch pad control section 21 detected a move, the touch event processing section 22 notifies the display control section 24 of a scrolling operation. The display control section 24 in turn initiates scrolling of the list image 8 (see (d) of FIG. 4) (step S12).

The touch event processing section 22 then determines whether a condition of the touch pad control section 21 having not detected a touch down for the predetermined period of time after the touch pad control section 21 detected a touch-up is fulfilled (step S13). Unless such a condition is fulfilled, the step S11 is proceeded with, i.e., the touch event processing section 22 continues to scroll the list image 8. The reason, why the above condition requires that the touch pad control section has not detected a touchdown for a predetermined period of time, is that malfunctions in the scroll mode are to be prevented.

On the other hand, in a case where the above condition is fulfilled, the touch event processing section 22 controls the display control section 24 to undergo a transition from the scroll mode to the pointer mode (step S14). This enables the user to point and select an item in the list image 8.

The touch event processing section 22 and the application control section 23 each take their own share of the above function. Embodiment 1 is, however, not limited as such. A part of the function of one of the touch event processing section 22 and the application control section 23 can be borne by the other. Alternatively, the touch event processing section 22 and the application control section 23 can be realized by a single control section which carries out their functions.

### Embodiment 2

The following description will discuss Embodiment 2 of the present invention. For convenience, members having identical functions to those described in Embodiment 1, and the steps in which identical processes to those described in Embodiment 1 are carried out are given respective identical reference signs. Their explanations are therefore omitted.

In Embodiment 2, the threshold time T1 is set to be shorter than the threshold time T2. The display control section 24 is controlled to undergo a transition from a pointer mode to a scroll mode, in a case where a touch duration time passed beyond the threshold time T1. Furthermore, the touch event processing section 22 and the application control section 23 control the display control section 24 to undergo a transition from the scroll mode to the pointer mode, in accordance with the type of an action to be initiated by the application control section 23, in a case where the touch duration time passed beyond the threshold time T2. In some cases, it is preferable for the display control section to operate in the pointer mode after the action is initiated, depending on a content of the action. According to Embodiment 2, a user can realize an initiation of the action and realize a transition to the pointer mode, without detaching his/her finger 4 from the touch pad 16.

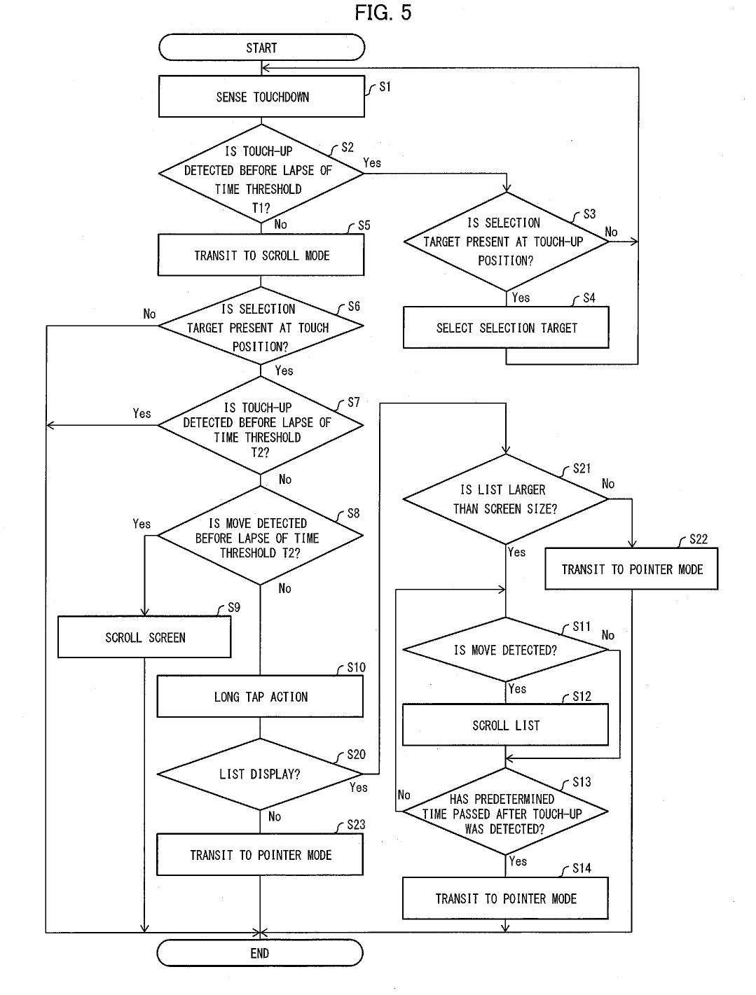

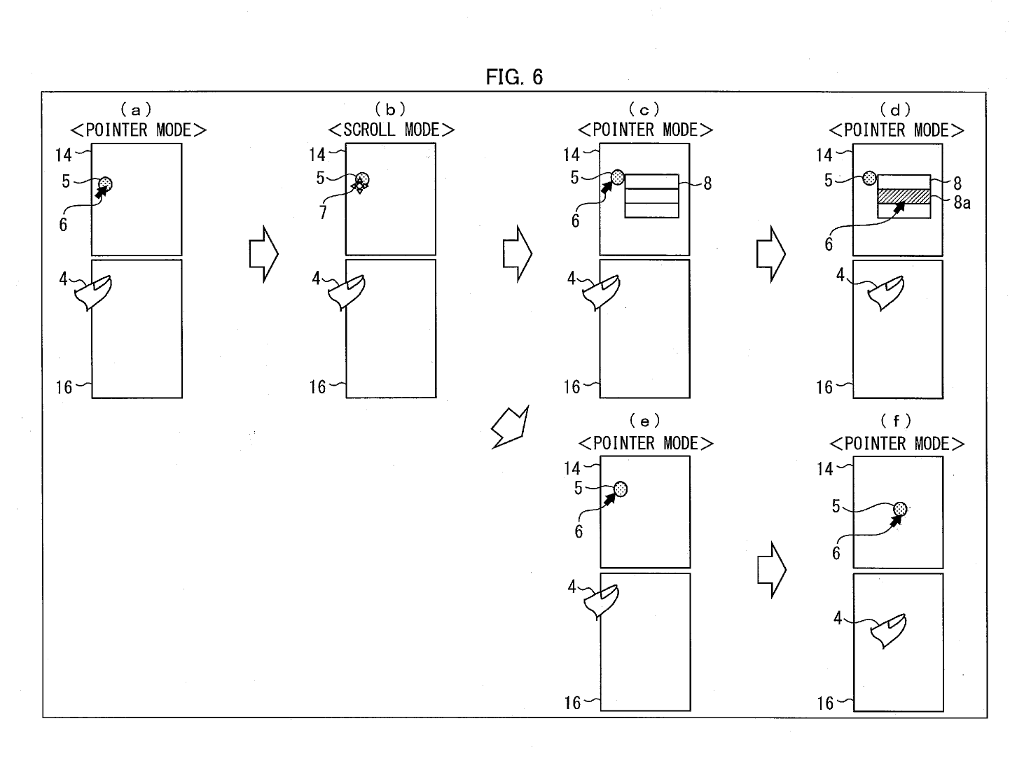

The following description will discuss in detail, with reference to FIGS. 5 and 6, how to process in Embodiment 2, in a case where a user long presses on a touch pad. FIG. 5 is a flowchart illustrating an example process which is carried out in a case where a user long presses on the touch pad in Embodiment 2. FIG. 6 is a drawing illustrating the example process.

The steps S1 through S10 are first carried out in a similar manner to Embodiment 1(see (a), (b), (c), and (e) of FIG. 6). The touch event processing section 22 then obtains, from the application control section 23, information as to whether an initiated action is displaying of the list image 8 (step S20).

In a case where the initiated action of the application control section 23 is the displaying of the list image 8 (see (c) of FIG. 6), the touch event processing section 22 first obtains information on the size of the list image 8 from the application control section 23, and then determines whether the size of the list image 8 is larger than the size of the display region (screen size) of the display section 14 (step S21). The steps S11 through S14 are proceeded with similarly with Embodiment 1, in a case where (i) the size of the list image 8 is larger than the screen size and (ii) it is necessary to scroll the list image 8. On the other hand, in a case where the size of the list image 8 is not larger than the screen size, the touch event processing section 22 controls the display control section 24 to undergo a transition to the pointer mode (step S22). This enables a user to select, as illustrated in (d) of FIG. 6, an item 8a in the list image 8 without temporarily detaching the finger 4 from the touch pad 16. This consequently allows the user to conduct a simpler operation.

The touch event processing section 22 controls the display control section 24 to undergo a transition to the pointer mode (step S23), even in a case where the action initiated by the application control section 23 is not displaying of the list image 8 but, for example, the initiation of a drag operation of an alternative 5 as illustrated in (e) of FIG. 6. This enables a user to drag the alternative 5 without temporarily detaching his/her finger 4 from the touch pad 16 (see (f) of FIG. 6). This allows a simpler operation to be realized. Note that if the user detaches the finger 4 from the touch pad 16 and the touch pad control section 21 detects a touch-up, then the application control section 23 can conduct a drop operation.

### Embodiment 3

The following description will discuss Embodiment 3 of the present invention. For convenience, members having identical functions to those described in Embodiments 1 and 2 and the steps in which identical processes to those described in Embodiments 1 and 2 are carried out are given respective identical reference signs. Their explanations are therefore omitted.

In Embodiment 3, a threshold time T3 is further set, and the threshold time T2 is shorter than the threshold time T3. The touch event processing section 22 and the application control section 23 cause the list image 8 to be overlaid on the display region of the display section 14, in a case where a touch duration time becomes longer than the threshold time T2. The display control section 24 undergoes transition into the scroll mode and causes the list image 8 to scroll in accordance with a change in positional information, in a case where the touch duration time becomes longer than the threshold time T3. This enables a user to carry out (i) displaying of the list image 8 and (ii) scrolling of the list image 8, without detaching his/her finger 4 from the touch pad 16.

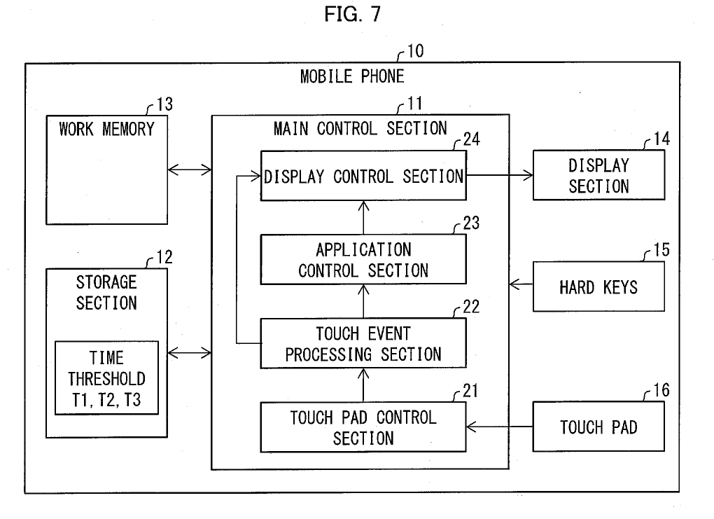

FIG. 7 is a block diagram illustrating a configuration of a main part of a mobile phone in accordance with Embodiment 3. As illustrated in FIG. 7, in Embodiment 3, the storage section 12 stores therein the threshold time T3 (first threshold time), in addition to the threshold time T1 and the threshold time T2 (second threshold time).

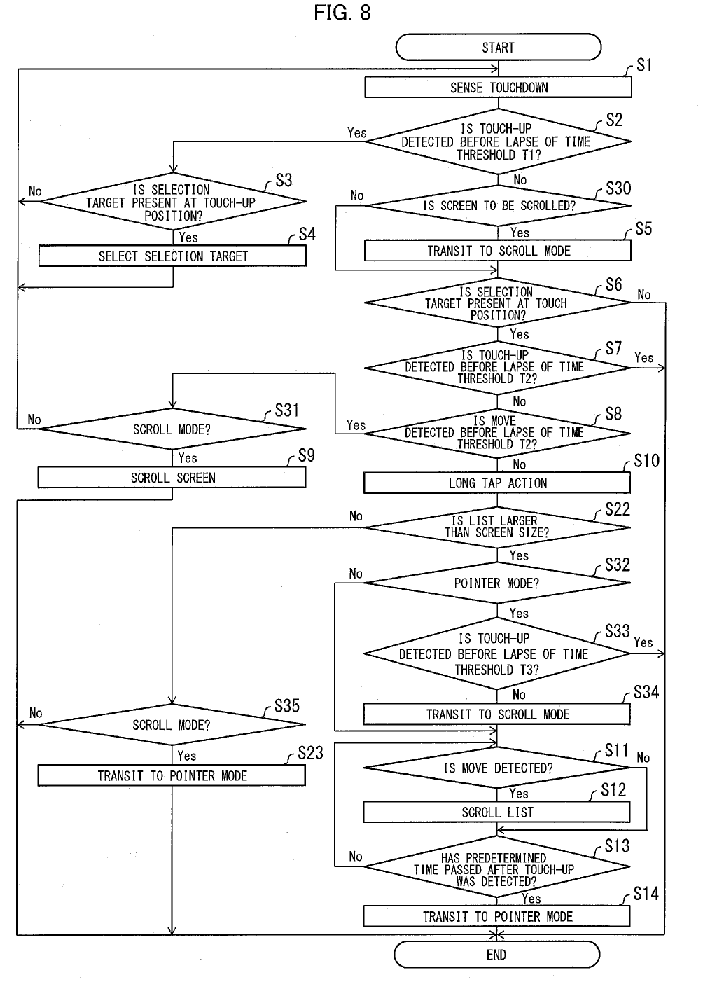

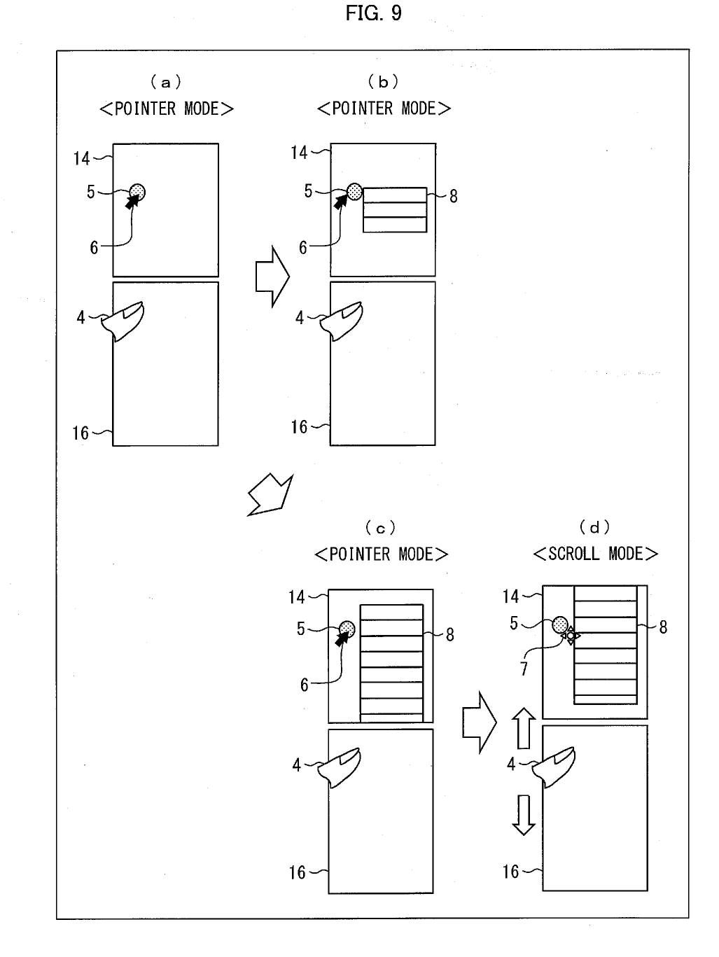

The following description will discuss in detail, with reference to FIGS. 8 and 9, how to process in Embodiment 3, in a case where a user long presses on a touch pad. FIG. 8 is a flowchart illustrating an example process which is carried out in a case where a user long presses on the touch pad in Embodiment 3. FIG. 9 is a drawing illustrating the example process.

The steps S1 through S4 are carried out in a similar manner to Embodiment 1 (see (a) of FIG. 9). The touch event processing section 22 then obtains, from the display control section 24, information as to whether the display region (screen) of the display section 14 is scrollable or not (step S30). In a case where the display region of the display section 14 is scrollable, the touch event processing section 22 carries out the steps S5 through S10 in a similar manner to Embodiment 1, and then performs the step S22 in a similar manner to Example 2, and performs the subsequent process in a similar manner to Example 2.

On the other hand, in a case where the display region of the display section 14 is not scrollable, the touch event processing section 22 carries out the steps S6 through S8 and S10 (see (b) and (c) of FIG. 9) while maintaining the pointer mode, instead of carrying out the step S5. Note, however, that in a case where a move is detected before the touch duration time passes beyond the threshold time T2 in the step S8, the step S9 is not proceeded with but the step S1 is proceeded with, via the step S31. This is because the mode is not the scroll mode.

Subsequently, the touch event processing section 22 obtains information on the size of the list image 8 from the application control section 23, and then determines whether the size is larger than the size of the display region (screen size) of the display section 14 (step S22). In so doing, in a case where the size of the list image 8 is not larger than the screen size (see (b) of FIG. 9), the mode is already the pointer mode. The touch event processing section 22 therefore ends the process corresponding to the long pressing.

On the other hand, in a case where (i) the size of the list image 8 is larger than the screen size and (ii) it is necessary to scroll the list image 8 (see (c) of FIG. 9), the touch event processing section 22 starts to determine whether a touch-up was detected before the touch duration time passes beyond the threshold time T3 (step S33). In a case where a touch-up was detected before the touch duration time passes beyond the threshold time T3, the touch event processing section 22 ends the process corresponding to the long pressing. On the other hand, in a case where no touch-up was detected before the touch duration time passes beyond the threshold time T3, the touch event processing section 22 controls the display control section 24 to undergo a transition to the scroll mode (step S34), and carries out the steps S11 through S14 similarly with Embodiment 1. This enables a user to scroll the list image 8 without temporarily detaching his/her finger 4 from the touch pad 16 as illustrated in (d) of FIG. 19. This consequently allows the user to conduct a simpler operation.

[Example Realized with Use of Software]

Control blocks (in particular, the touch pad control section 21, the touch event processing section 22, the application control section 23, and the display control section 24 of the main control section 11) of the mobile phone 10 can be realized by a logic circuit (hardware) provided in an integrated circuit (IC chip) or the like or can be alternatively realized by software as executed by a central processing unit (CPU).

In the latter case, the mobile phone 10 includes a CPU that executes instructions of a program that is software realizing the foregoing functions; a read only memory (ROM) or a storage device (each referred to as “storage medium”) in which the program and various kinds of data are stored so as to be readable by a computer (or a CPU); and a random access memory (RAM) in which the program is loaded. An object of the present invention can be achieved by a computer (or a CPU) reading and executing the program stored in the storage medium. Examples of the storage medium encompass “a non-transitory tangible medium” such as a tape, a disk, a card, a semiconductor memory, and a programmable logic circuit. The program can be supplied to the computer via any transmission medium (such as a communication network or a broadcast wave) which allows the program to be transmitted. Note that the present invention can also be achieved in the form of a computer data signal in which the program is embodied via electronic transmission and which is embedded in a carrier wave.

### SUMMARY

An information processing apparatus (mobile phone 10) in accordance with aspect 1 of the present invention includes: a display section 14; an object detecting section (touch pad 16), having a planar detection region where an object which comes close to or is in touch with the detection region is detected, the detection region being located differently from a display region of the display section; a positional information obtaining section (touch pad control section 21) configured to obtain positional information indicative of a location where the object detecting section detected the object; a display control section 24 configured to, (i) in a first mode (pointer mode), determine a location of a pointer on the display region in accordance with the positional information and (ii) in a second mode (scroll mode), control at least a part of the display region to scroll in accordance with a change in the positional information; and an operation control section (touch event processing section 22 and application control section 23) configured to (i) control the display control section to undergo a transition from the first mode to the second mode, in a case where a duration time, during which the positional information continues to indicate a same location, passed beyond a first threshold time (threshold time T1, threshold time T3), and (ii) initiate an action corresponding to the location of the pointer, in a case where the duration time passed beyond a second threshold time (threshold time T2).

According to the above aspect, in the case where the duration time, during which the positional information indicative of the location at which the object detecting section detected the object continues to indicate a same location, passed beyond the first threshold time, the display control section is caused to undergo a transition from the first mode to the second mode, and in the case where the duration time passed beyond the second threshold time, the action corresponding to the location of the pointer is initiated. Consequently, a user can successively undergo (i) a transition from the first mode to the second mode and (ii) other action, without temporarily detaching the object from the object detecting section. This allows realizing a simpler operation.

The information processing apparatus in accordance with aspect 2 of the present invention may be an arrangement of the aspect 1, wherein the first threshold time (threshold time T1) is shorter than the second threshold (threshold time T2), the operation control section controls the display region to display an overlaid display image (list image 8), in a case where the duration time passed beyond the second threshold time, and the display control section causes the overlaid display image to scroll in accordance with a change in the positional information, in a case where the overlaid display image is displayed in the second mode to which the display control section underwent the transition from the first mode when the duration time passed beyond the first threshold time.

According to the above aspect, in the case where the duration time passed beyond the first threshold time, the display control section undergoes a transition from the first mode to the second mode, and thereafter, in the case where the duration time passed beyond the second threshold time, the overlaid display image is displayed on the display region and scrolled in accordance with a change in the positional information. This enables a user to successively perform (i) a transition from the first mode to the second mode, (ii) displaying of the overlaid display image, and (iii) scrolling of the overlaid display image, without temporarily detaching the object from the object detection section. This allows a further simpler operation.

The information processing apparatus in accordance with aspect 3 of the present invention may be an arrangement of the aspect 1 or 2, wherein the first threshold time (threshold time T1) is shorter than the second threshold time (threshold time T2), and the operation control section controls the display control section to undergo a transition from the second mode to the first mode, in a case where the duration time passed beyond the second threshold time.

Depending on the content of the action, there is a case where it is preferable for the display control section to operate in the first mode after the action. According to the above aspect, after the action has been performed, the display control section can be controlled to automatically undergo a transition from the second mode to the first mode. This enables a user to successively perform (i) the action and (ii) a transition from the second mode to the first mode, without temporarily detaching the object from the object detecting section. This allows a further simpler operation.

The information processing apparatus in accordance with aspect 4 of the present invention may be an arrangement of the aspect 1, wherein the second threshold time (threshold time T2) is shorter than the first threshold time (threshold time T3), the operation control section controls the display region to display an overlaid display image (list image 8), in a case where the duration time passed beyond the second threshold time, and the display control section undergoes a transition from the first mode to the second mode and controls the overlaid display image to scroll in accordance with a change in the positional information, in a case where the duration time passed beyond the first threshold time.

According to the above aspect, in the case where the duration time passed beyond the second threshold time, the overlaid display image is displayed on the display region, and thereafter in the case where the duration time passed beyond the first threshold time, the display control section undergoes a transition from the first mode to the second mode and the overlaid image is scrolled in accordance with a change in the positional information. This enables a user to successively perform (i) displaying of the overlaid display image, (ii) a transition from the first mode to the second mode, and (iii) scrolling of the overlaid display image, without temporarily detaching the object from the object detection section. This allows a further simpler operation.

A method in accordance with aspect 5 of the present invention of controlling an information processing apparatus is a method of controlling an information processing apparatus, said apparatus including: a display section 14; an object detecting section (touch pad 16), having a planar detection region where an object which comes close to or is in touch with the detection region is detected, the detection region being located differently from a display region of the display section; and a positional information obtaining section (touch pad control section 21) configured to obtain positional information indicative of a location where the object detecting section detected the object, said method comprising the steps of: (a) in a first mode (pointer mode), determining a location of a pointer on the display region in accordance with the positional information, and in a second mode (scroll mode), controlling at least a part of the display region to scroll in accordance with a change in the positional information; and (b) undergoing, in the step (a), a transition from the first mode to the second mode, in a case where a duration time, during which the positional information continues to indicate a same location, passed beyond a first threshold time, and initiating an action corresponding to the location of the pointer, in a case where the duration time passed beyond a second threshold time.

According to the above aspect, an effect equal to that of the image forming apparatus in accordance with the aspect 1 can be yielded.

The information processing apparatus in accordance with the aspects of the present invention may be realized by a computer. In this case, the present invention also encompasses a control program for an information processing apparatus which program causes a computer to operate sections (software elements: the display control section and the operation control section) of the information processing apparatus so as to realize the information processing apparatus by the computer, and a computer-readable storage medium in which the control program is stored.

The present invention is not limited to the embodiments, but can be altered by a skilled person in the art within the scope of the claims. An embodiment derived from a proper combination of technical means each disclosed in a different embodiment is also encompassed in the technical scope of the present invention. Further, it is possible to form a new technical feature by combining the technical means disclosed in the respective embodiments.

### INDUSTRIAL APPLICABILITY

The present invention is usable generally for an information processing apparatus including a display section and an object detecting section.

### REFERENCE SIGNS LIST

4 Finger (object)
5 Selection target
6, 7 Cursor
8 List image (overlaid display image)
10 Mobile phone (information processing device)
14 Display section
16 Touch pad (object detecting section)
21 Touch pad control section (positional information obtaining section)
22 Touch event processing section (operation control section)
23 Application control section (operation control section)
24 Display control section
T1 Threshold time (first threshold)
T2 Threshold time (second threshold)
T3 Threshold time (first threshold)

1. An information processing apparatus, comprising:
a display section;
an object detecting section, having a planar detection region where an object which comes close to or is in touch with the detection region is detected, the detection region being located differently from a display region of the display section;
a positional information obtaining section configured to obtain positional information indicative of a location where the object detecting section detected the object;
a display control section configured to, (i) in a first mode, determine a location of a pointer on the display region in accordance with the positional information and (ii) in a second mode, control at least a part of the display region to scroll in accordance with a change in the positional information; and
an operation control section configured to (i) control the display control section to undergo a transition from the first mode to the second mode, in a case where a duration time, during which the positional information continues to indicate a same location, passed beyond a first threshold time, and (ii) initiate an action corresponding to the location of the pointer, in a case where the duration time passed beyond a second threshold time.

2. The information processing apparatus as set forth in claim 1, wherein
the first threshold time is shorter than the second threshold time,
the operation control section controls the display region to display an overlaid display image, in a case where the duration time passed beyond the second threshold time, and
the display control section controls the overlaid display image to scroll in accordance with a change in the positional information, in a case where the overlaid display image is displayed in the second mode to which the display control section underwent the transition from the first mode when the duration time passed beyond the first threshold time.

3. The information processing apparatus as set forth in claim 1, wherein
the first threshold time is shorter than the second threshold time, and
the operation control section controls the display control section to undergo a transition from the second mode to the first mode, in a case where the duration time passed beyond the second threshold time.

4. The information processing apparatus as set forth in claim 1, wherein
the second threshold time is shorter than the first threshold time,
the operation control section controls the display region to display an overlaid display image, in a case where the duration time passed beyond the second threshold time, and
the display control section undergoes a transition from the first mode to the second mode and controls the overlaid display image to scroll in accordance with a change in the positional information, in a case where the duration time passed beyond the first threshold time.

5. A method of controlling an information processing apparatus,
said apparatus comprising:
a display section;
an object detecting section, having a planar detection region where an object which comes close to or is in touch with the detection region is detected, the detection region being located differently from a display region of the display section; and
a positional information obtaining section configured to obtain positional information indicative of a location where the object detecting section detected the object,
said method comprising the steps of:
(a) in a first mode, determining a location of a pointer on the display region in accordance with the positional information, and in a second mode, controlling at least a part of the display region to scroll in accordance with a change in the positional information; and
(b) undergoing, in the step (a), a transition from the first mode to the second mode, in a case where a duration time, during which the positional information continues to indicate a same location, passed beyond a first threshold time, and initiating an action corresponding to the location of the pointer, in a case where the duration time passed beyond a second threshold time.
